(19) United States
(12) Patent Application Publication
(10) Pub. No.: US 2017/0348838 A1
(43) Pub. Date: Dec. 7, 2017

(54) Cotter Pin Assist Device

(71) Applicant: Truck Shields, LLC, Salt Lake City, UT (US)

(72) Inventor: Dennis H. Hancock, Evanston, WY (US)

(21) Appl. No.: 15/418,442

(22) Filed: Jan. 27, 2017

Related U.S. Application Data
(60) Provisional application No. 62/344,902, filed on Jun. 2, 2016.

(51) Int. Cl. B25B 27/08

(52) U.S. Cl. CPC B25B 27/08

(57) ABSTRACT

A cotter pin assist device that eliminates the need to use a separate tool to insert and/or extract a cotter, or other fastening, pin. The cotter pin assist device allows the user to easily insert or extract a cotter pin in locations that are difficult to reach, in all types of weather and virtually all conditions.

### CROSS REFERENCE TO RELATED APPLICATION

This application claims the benefit of U.S. Provisional Application Ser. No. 62/344,902 filed Jun. 2, 2016 by Dennis Hancock.

### FIELD OF THE INVENTION

The present invention relates generally to cotter pin insertion and extraction devices, and more particularly to a cotter pin assist device that assists the user in inserting and removing a cotter pin without the need of an external tool.

### BACKGROUND OF THE INVENTION

A cotter pin (also known as a R-pin, cotter pin or hairpin cotter pin) is a fastener made of springy material, usually hardened metal wire. Cotter pins are commonly used to secure the ends of round shafts such as axles and clevis pins. The straight leg of the cotter pin is pushed through a hole at one end of a shaft until the middle, or belly, of the other bent leg of the cotter pin grips the side of the shaft away from the straight leg. The cotter is usually bent so that it remains in constant tension and will not come loose from the hole into which it has been inserted without the user applying some force to remove. The end of the bent leg most often is built to point away from the straight leg to facilitate insertion of the cotter pin.

Cotter pins are frequently used in connecting various components and can be located in recessed locations with limited access that hinder the user's ability to insert and extract the cotter pin. Others have attempted to solve the problem of inserting and extracting a cotter pin by designing tools that are separate from the cotter pin, such as cotter pin extracting pliers. In a typical scenario, a cotter pin is used to secure a ball mount hitch to the receiver tube on a vehicle. Once the hitch is inserted into the receiver tube, a hitch pin is inserted through holes located in the hitch and receiver. A cotter pin is then inserted into a hole in the hitch pin to prevent the hitch pin from falling out. When dealing with this scenario, the last thing a user should have to worry about is locating a tool to help with the insertion and extraction of the cotter pin. In addition, such a tool is often useless in facilitating the insertion of a cotter pin.

Accordingly, there continues to be a need for a new and improved cotter pin assist device as set forth in the present invention, which addresses the problems of ease of use as well as being effective in allowing a user to insert and extract a cotter pin. The present invention fulfills this need.

### SUMMARY OF THE INVENTION

To solve the existing problems with known cotter pin assist devices, the present invention provides a cotter pin assist device that is attached to a cotter pin and provides means for the user to effectively grip the cotter pin to either insert or extract it without having to locate and use a separate tool.

Another object of this invention is to provide a device that includes an insertion portion for grasping a cotter pin to allow for easy insertion of a cotter pin into a hitch pin without using a separate tool.

Another object of the invention is to provide a device that includes an extraction portion that allows for easy removal of a cotter pin from a hitch without using a separate tool.

Another object of the invention is to provide a device that can be easily grasped by the user to insert or extract a cotter pin. An advantage of the device is that the insertion function and extraction function can be accomplished by a single device that is attached to the cotter pin.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a perspective view of the side of the invention.

FIG. 2 is perspective view of the side and an end of the invention.

FIG. 3 is a side view of the invention.

FIG. 4 is a bottom view of the invention.

FIG. 5 is an end view of the invention.

FIG. 6 is a side view of the invention.

FIG. 7 is a top view of the invention.

FIG. 8 is an end view of the invention.

FIG. 9 is a perspective view of the interior of the invention.

FIG. 10 is a perspective view showing the invention inserted into a hitch pin.

### DETAILED DESCRIPTION OF THE INVENTION

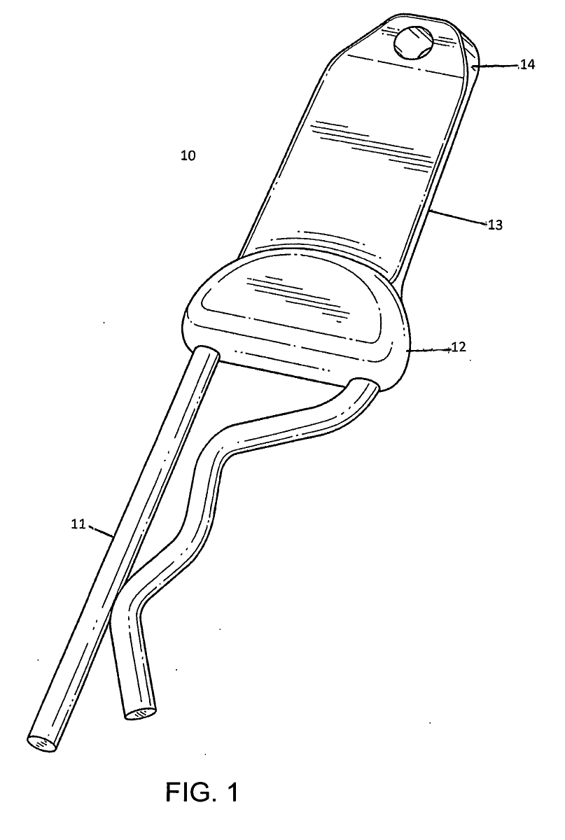

FIG. 1 shows the cotter pin assist device 10 attached to a cotter pin 11. In a preferred embodiment, the cotter pin assist device 10 is made out of a flexible material and is fixedly attached to the cotter pin 11. The end of the cotter pin 11 is encased in the flexible material, which material is thicker around the cotter pin 11 and insertion end 12, tapers off in the middle section 13 and is thicker again at the extraction end 14. The difference in thickness at the insertion end 12 and middle section 13 provides a grip that the user holds when inserting the cotter pin 11. It also provides stability to the cotter pin 11 when it is inserted. While it is useful to vary the thickness between the insertion end 12 and middle section 13 of the cotter pin assist device 10, the device can also be made of a uniform thickness. The durometer of the present invention can be varied in order to increase or decrease the tension of the cotter pin 11. For instance a material with a higher durometer will cause the tension in the cotter pin 11 to be stronger, making the cotter pin 11 more difficult to insert or withdraw. A material with a lower durometer will cause less tension in the cotter pin 11, making it easier to insert or withdraw. Depending on how the cotter pin 11 is being used, the durometer of the material can be varied to best meet the user's desired purpose.

When it is desired to remove the cotter pin 11, the user grasps the extraction end 14 of the cotter pin assist device 10, which has a grip that results from the flexible material on the extraction end 14 being thicker than the middle portion 13 of the invention. Instead of reaching for a separate tool like a pair of pliers or a screwdriver, the user simply grabs the raised extraction end 14 and pulls to remove the cotter pin 11. Often in the circumstances when a cotter pin is being utilized, the user will be wearing gloves. Because of the tapered ends 12 and 14 of the present invention, a user can easily insert or extract a cotter pin with our without gloves. The user can also extract the pin from various angles because of the flexibility of the cotter pin assist device 10. This is particularly useful when the desired pin to be removed is in a hard to reach location. The user can simply grasp the extraction end 14 of the assist device 10 and pull to extract the pin without the need to pull in a direction that is parallel to the pin.

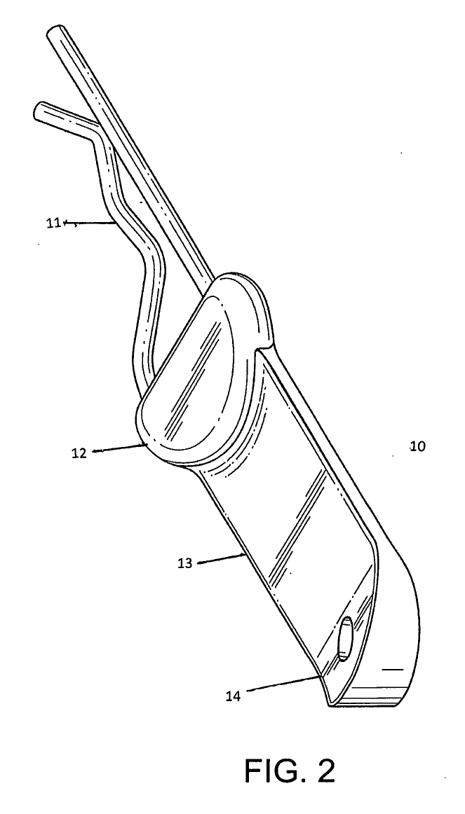

In FIGS. 2, 4 and 7, the difference in thickness between the insertion end 12, middle section 13 and extraction end 14 is shown. While the present invention is shown being fixedly attached to a cotter pin 11, it is understood that a cotter pin assist device 10 could also be removably attached to a cotter pin 11. The present invention is also shown as being a single molded piece, which is the most desirable configuration, but it is also understood that a device consisting of multiple parts could also be used.

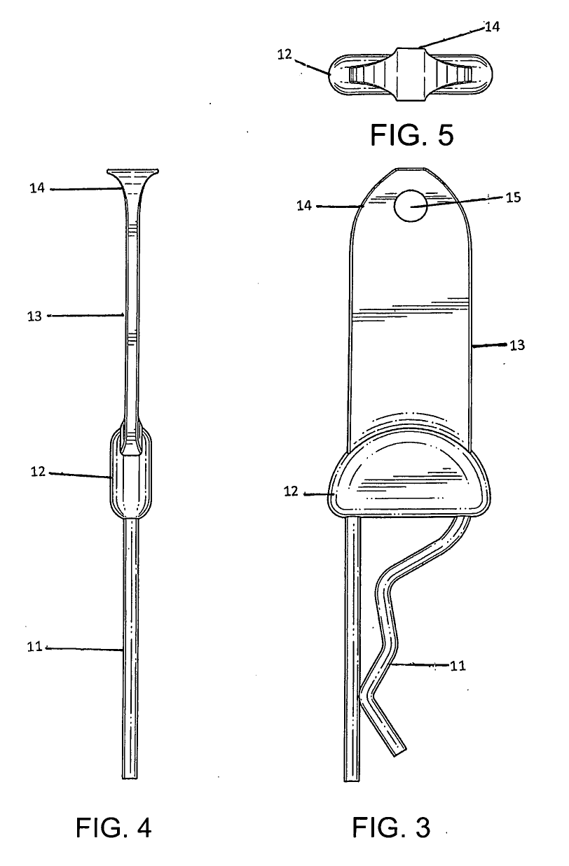

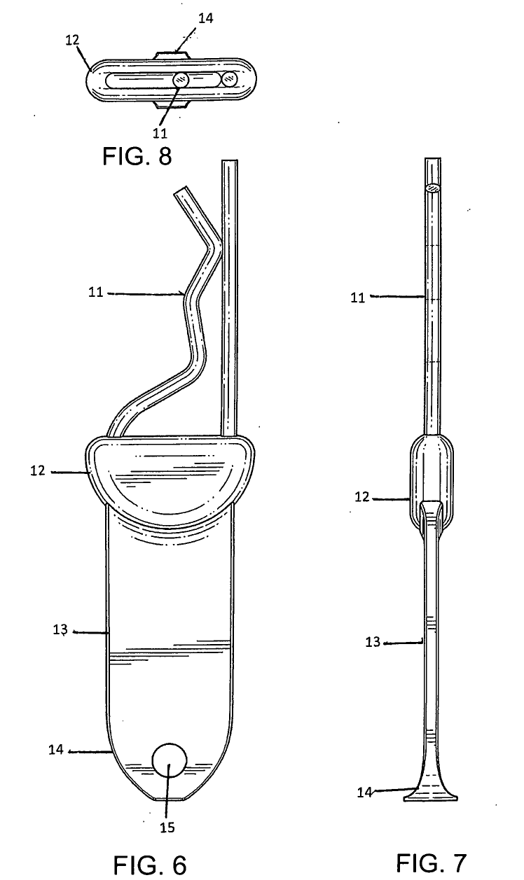

FIGS. 3 and 6 show opposite sides of the cotter pin assist device and illustrate that insertion end 12 is created when the desired flexible material is formed around cotter pin 11. There is a hole 15 in the extraction end of the device to allow for easy storage of the cotter pin assist device.

FIG. 5 shows the thickness of extraction end 14 of the cotter pin assist device 10 in relation to middle portion 13 and insertion end 12. It shows that the extraction end 14 can be easily grasped to assist in the extraction of a cotter pin.

FIG. 8 is an end perspective that shows cotter pin 11 in relation to insertion end 12. It shows that the thickness of insertion end 12 enables a user to get a better grip on the cotter pin 11 to allow for easy insertion of the cotter pin 11.

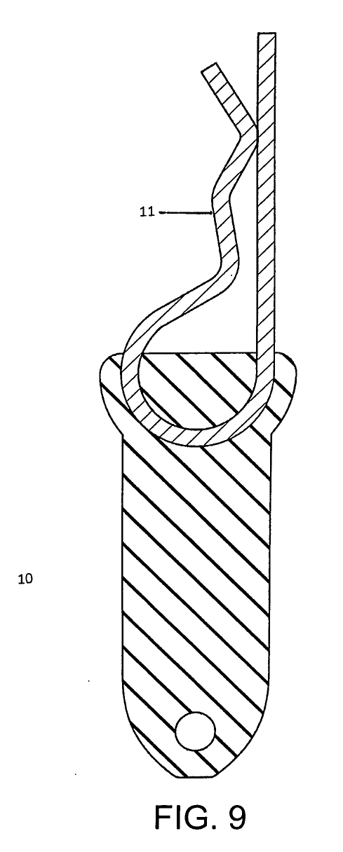

FIG. 9 is a cutaway of the present invention, showing the location of the cotter pin 11 embedded in the flexible material on the insertion end 12 of the cotter pin assist device 10.

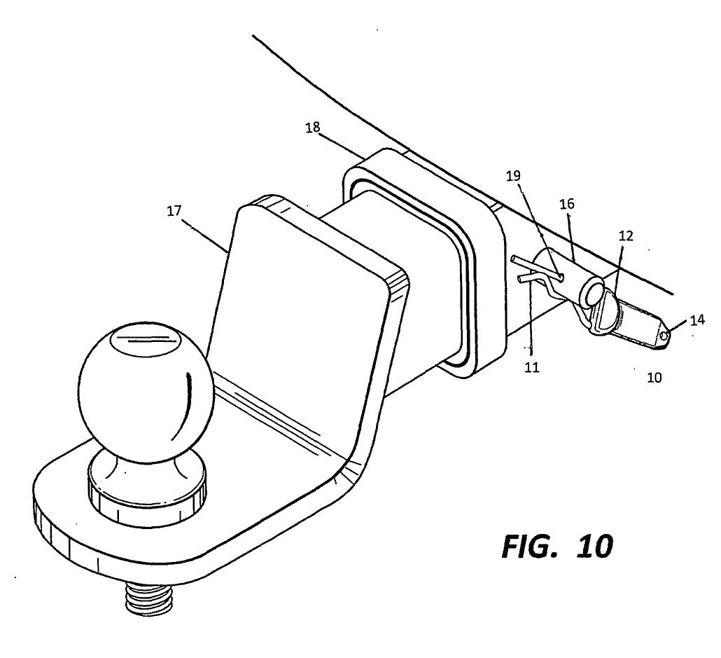

FIG. 10 shows a cotter pin 11 attached to cotter pin assist device 10 inserted into a hitch pin 16. The hitch pin 16 is used to secure a hitch 17 to a receiver 18. In this fashion, the user gripped the cotter pin assist device 10 at the insertion end 12 and pushed it through hole 19 in hitch pin 16. In order to remove the hitch pin 16, the user would grip the cotter pin assist device 10 at the extraction end 14, extract cotter pin 11 and then remove hitch pin 16. Once hitch pin 16 is removed, the user can remove hitch 17 from receiver 18.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

I claim as my invention:

1. A cotter pin assist device comprising:
an insertion end fixedly attached to a cotter, or other fastening, pin that is thicker than the cotter, or other fastening, pin;
a middle portion connected to said insertion end that tapers off from said insertion end to be of a lesser thickness than said insertion end; and
an extraction end connected to said middle portion that increases in thickness from said middle portion to a thickness similar to the thickness of said insertion end.

2. The cotter pin assist device of claim 1 wherein said device is made of a flexible material.

3. The cotter pin assist device of claim 2 wherein said flexible material varies in durometer.

4. A cotter pin assist device comprising:
an insertion end removably attached to a cotter, or other fastening, pin that is thicker than the cotter, or other fastening, pin;
a middle portion connected to said insertion end that tapers off from said insertion end to be of a lesser thickness than said insertion end; and
an extraction end connected to said middle portion that increases in thickness from said middle portion to a thickness similar to the thickness of said insertion end.

5. The cotter pin assist device of claim 4 wherein said device is made of a flexible material.

6. The cotter pin assist device of claim 5 wherein said flexible material varies in durometer.

7. A cotter pin assist device comprising:
an insertion end fixedly attached to a cotter, or other fastening, pin that is thicker than the cotter, or other fastening, pin;
a middle portion connected to said insertion end; and
an extraction end connected to said middle portion.

8. The cotter pin assist device of claim 7 wherein said device is made of a flexible material.

9. The cotter pin assist device of claim 8 wherein said flexible material varies in durometer.

10. A cotter pin assist device comprising:
an insertion end removably attached to a cotter, or other fastening, pin that is thicker than the cotter, or other fastening, pin;
a middle portion connected to said insertion end; and
an extraction end connected to said middle portion.

11. The cotter pin assist device of claim 10 wherein said device is made of a flexible material.

12. The cotter pin assist device of claim 11 wherein said flexible material varies in durometer.

13. A fastening pin assist device comprising:
an insertion end fixedly attached to a fastening pin that is thicker than the fastening pin;
a middle portion connected to said insertion end that tapers off from said insertion end to be of a lesser thickness than said insertion end; and
an extraction end connected to said middle portion that increases in thickness from said middle portion to a thickness similar to the thickness of said insertion end.
